(19) United States
(12) Patent Application Publication
(10) Pub. No.: US 2009/0132416 A1
(43) Pub. Date: May 21, 2009

(54) TAGGING VIRTUAL CURRENCY

(75) Inventors: Tobin R. Titus, Issaquah, WA (US); Ernest A. Booth, Bellevue, WA (US); Erik Porter, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,625

(22) Filed: Nov. 21, 2007

(51) Int. Cl. G06Q 40/00; G06Q 90/00

(52) U.S. Cl. 705/44

(57) ABSTRACT

Technologies are described herein for providing tagging virtual currency and processing payments made by the virtual currency. In an example, a virtual currency unit is received as payment for a good or service. Whether the virtual currency unit is associated with a tag is determined. Upon determining that the virtual currency unit is associated with a tag, whether the tag permits a utilization of the virtual currency unit as payment for the good or service is determined. Upon determining that the tag permits the utilization of the virtual currency unit as payment for the good or service, the payment of the virtual currency unit for the good or service is processed. Upon determining that the tag prohibits the utilization of the virtual currency unit as payment for the good or service, the payment of the virtual currency unit for the good or service is denied.

### BACKGROUND

In recent years, massively multiplayer online (“MMO”) computer applications, such as massively multiplayer role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

The environment in the virtual world may be governed, at least in part, by a virtual economy, which typically involves the exchange of virtual currency for real and virtual goods and services. In some cases, the virtual currency may be entirely synthetic, while in other cases, the virtual currency may be exchanged for real currency. The presence of a virtual economy, and in particular, virtual currency, may help expand the virtual world by providing an incentive for creating, buying, and/or selling goods and services within the virtual world. For example, user-generated content may be sold within the virtual world in exchange for a given amount of virtual currency. In this case, a quid pro quo is established in which a customer receives the user-generated content, while a content creator receives an economic benefit that may encourage the content creator to generate other content.

It is with respect to these considerations and others that the disclosure made herein is presented.

### SUMMARY

Technologies are described herein for tagging virtual currency as well as processing payments made by the virtual currency. In particular, through the utilization of the technologies and concepts presented herein, a virtual currency unit may be associated with a tag that specifies permissible and/or impermissible uses of the virtual currency unit. As used herein, a virtual currency unit refers to a given amount of virtual currency. Examples of virtual currency include points, tokens, coin, virtual cash, virtual credit, and the like. Each virtual currency unit may or may not have a corresponding real currency value.

According to one aspect presented herein, a computer program provides for processing a payment made by virtual currency. The computer program receives a virtual currency unit as payment for a good or service. The computer program determines whether the virtual currency unit is associated with a tag. Upon determining that the virtual currency unit is associated with a tag, the computer program determines whether the tag permits a utilization of the virtual currency unit as payment for the good or service. Further, upon determining that the tag permits the utilization of the virtual currency unit as payment for the good or service, the computer program processes the payment of the virtual currency unit for the good or service. In contrast, upon determining that the tag prohibits the utilization of the virtual currency unit as payment for the good or service, the computer program denies the payment of the virtual currency unit for the good or service.

It should be appreciated that although the features presented herein are described in the context of a virtual world, these features may be utilized in other contexts including, but not limited to, online social communities, Internet-based stores, and Internet-based auction websites. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing aspects of a network architecture capable of implementing a virtual world, in accordance with one embodiment;

FIG. 2 is a screen display diagram showing an illustrative screenshot of the virtual world, in accordance with one embodiment;

FIG. 3 is a screen display diagram showing an illustrative screenshot of a virtual currency unit generator, in accordance with one embodiment;

FIG. 4 is a screen display diagram showing an illustrative screenshot of a tag generator, in accordance with one embodiment;

FIG. 5 is a flow diagram showing an illustrative process for tagging virtual currency, in accordance with one embodiment;

FIG. 6 is a flow diagram showing an illustrative process for processing a payment made by virtual currency, in accordance with one embodiment; and

FIG. 7 is a computer architecture diagram showing aspects of an illustrative computer hardware architecture for a computing system capable of implementing the embodiments presented herein.

### DETAILED DESCRIPTION

The following detailed description is directed to technologies for tagging virtual currency and processing payments made by the virtual currency. Through the utilization of the technologies and concepts presented herein, a virtual currency unit may be associated with a tag that specifies a number of attributes, each of which corresponds to a permissible and/or impermissible use of the virtual currency unit. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

As used herein, a virtual currency unit refers to a given amount of virtual currency. Examples of virtual currency include points, tokens, coin, virtual cash, virtual credit, and the like. Virtual currency refers to a fictional unit of exchange that may be utilized to purchase real and/or virtual goods and services in a virtual world, for example. In one embodiment, a virtual currency unit has a corresponding real currency value, such as a given amount of United States dollars or other official currency. For example, the virtual currency unit may be acquired in exchange for real currency at a given exchange rate and/or real currency may be acquired in exchange for the virtual currency unit at the given exchange rate. In another embodiment, a virtual currency unit has no corresponding real currency value. In this case, the utilization of the virtual currency unit as payment for goods and services may be limited to the virtual world, for example.

Solely for illustrative purposes, virtual currency is described herein in the context of a virtual world. It should be appreciated that virtual currency is not so limited and may be utilized in a variety of other contexts as contemplated by those skilled in the art. Examples of other contexts in which virtual currency may be used include, but are not limited to, a social network website (e.g., FACEBOOK from FACEBOOK INCORPORTED), an Internet-based store (e.g., ZUNE MARKETPLACE from MICROSOFT CORPORATION, ITUNES from APPLE INCORPORATED), or an Internet-based auction website (e.g., EBAY from EBAY INCORPORATED).

As used herein, the term virtual world refers to a computer-implemented environment, which may include simulated, lifelike environments as well as fanciful, non-existing environments. Exemplary virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world is generally inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, and soda cans, as well as fanciful creations, such as a teleportation machine or a flying car. The avatars and the virtual objects utilized in the virtual world may or may not be animated images.

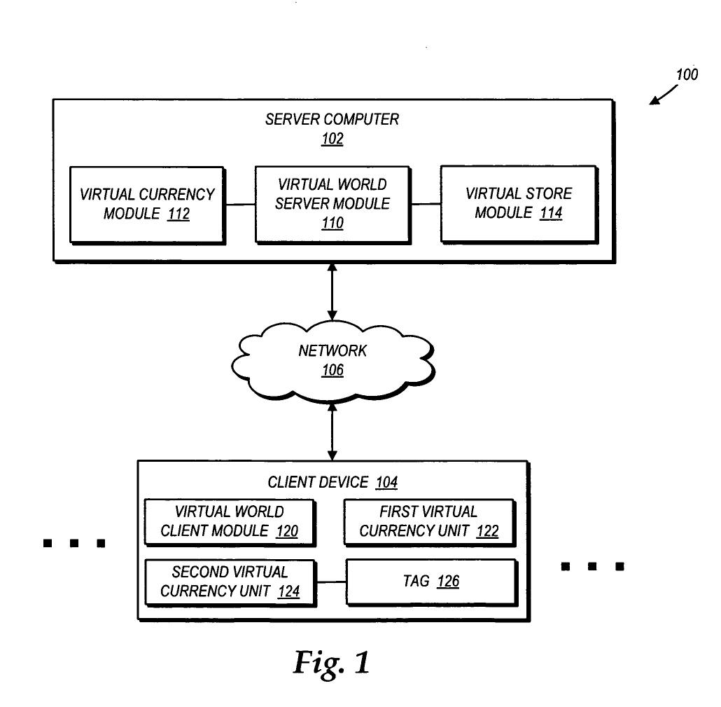

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for popularity-based licensing of participant-generated content will be described. In particular, FIG. 1 illustrates a simplified network architecture 100 for a virtual world. The network architecture 100 shown in FIG. 1 includes a server computer 102 and a client device 104, both of which are operatively coupled via a network 106. The network 106 may be any suitable network, such as a local area network (“LAN”) or the Internet. Although only one client device 104 is illustrated in FIG. 1, the network architecture 100 may include multiple client devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Exemplary peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with the virtual world server module 110 executing on the server computer 102. In particular, the virtual world client module 120 may receive and process data from a virtual world server module 110 and output the data to output devices coupled to the client device 104. Further, the virtual world client module 120 may receive data from input devices coupled to the client device 104 and transmit the data to the virtual world server module 110. The client device 104 may further include a first virtual currency unit 122 and a second virtual currency unit 124, as illustrated in FIG. 1. The second virtual currency unit 124 is associated with a tag 126, while the first virtual currency unit 122 is not associated with a tag. As described in greater detail below, the tag 126 specifies permissible and/or impermissible uses of the second virtual currency unit 124 in the virtual world.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

As shown in FIG. 1, the server computer 102 includes a virtual world server module 110, a virtual currency module 112, and a virtual store module 114. The virtual world server module 110 generally administers the virtual world and serves as a conduit between multiple client devices, including the client device 104. The virtual currency module 112 enforces proper usage of virtual currency units, such as the first virtual currency unit 122 and the second virtual currency unit 124, within the virtual world. In particular, the virtual currency module 112 enforces the permissible and/or impermissible uses of a virtual currency unit as specified by any associated tags. The virtual currency module 112 may also generate the tags to be associated with the virtual currency units. The virtual store module 114 provides access to one or more virtual stores that sell, in exchange for virtual currency, real and/or virtual goods and services.

When a participant desires to access the virtual world, the participant may initiate the virtual world client module 120 to establish a session with the virtual world server module 110 via the network 106. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110. By way of the virtual world server module 110 and the virtual currency module 112, the virtual world client module 120 may further interact with the virtual store module 114 to access real and/or virtual good and services that are for sale at one or more virtual stores. The virtual world client module 120 may further interact with the virtual currency module 112 in conjunction with the virtual store module 114 to manage payments made by virtual currency units at the virtual stores.

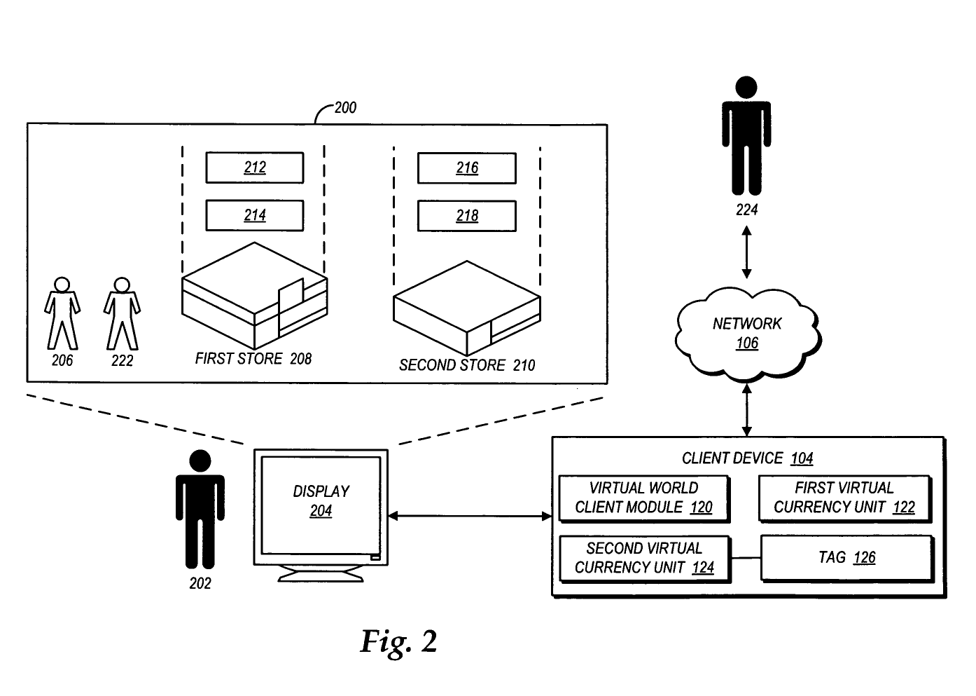

A number of exemplary screenshots of a virtual world provided by the virtual world client module 120 in conjunction with the virtual world server module 110 the will now be presented with reference to FIGS. 2, 3, and 4. It should be appreciated that the screenshots shown herein are merely illustrative. Other implementations of the virtual world may be utilized as contemplated by those skilled in the art.

Turning now to FIG. 2, an illustrative screenshot 200 of the virtual world provided by the virtual world client module 120 and the virtual world server module 110 is shown, in accordance with one embodiment. A first participant 202 may view the screenshot 200 on a display 204 operatively coupled to the client device 104. As shown in FIG. 2, the screenshot 200 includes a first avatar 206, a second avatar 222, a first store 208, and a second store 210. The first avatar 206 may be controlled by the first participant 202 utilizing the client device 104. For example, the first participant 202 may control the first avatar 206 utilizing any suitable input devices (not shown) coupled to the client device 104. The second avatar 222 may be controlled by a second participant 224 utilizing another client device (not shown) also coupled to network 106.

The first avatar 206 and the second avatar 222 are capable of entering the first store 208 or the second store 210. Upon entering the first store 208, the first avatar 206 and the second avatar 222 may purchase a first product 212 and a second product 214. Upon entering the second store 210, the first avatar 206 and the second avatar 222 may purchase a third product 216 and a fourth product 218. As shown in FIG. 2, the first virtual currency unit 122 is not associated with any tag. As such, the first virtual currency unit 122 may be used without any limitations other than those predefined by the virtual world. In one example, the first avatar 206 may utilize the first virtual currency unit 122 as payment to purchase the first and second products 212, 214 from the first store 208 and the third and fourth products 216, 218 from the second store 210. In another example, the first avatar 206 may assign the first virtual currency unit 122 to the second avatar 222, and the second avatar 222 may utilize the first virtual currency unit 122 in the same manner that the first avatar 206 is authorized to utilize the first virtual currency unit 122.

In contrast with the first virtual currency unit 122, the second virtual currency unit 124 is associated with a tag 126. In one embodiment, the tag 126 includes a schema that specifies the way in which the second virtual currency unit 124 may be utilized in the virtual world. In particular, the schema may include one or more attributes, each of which specifies a permissible use or an impermissible use of the second virtual currency unit 124. The schema may be written in extensible markup language (“XML”) or other suitable schema language.

In one example of a permissible use, the tag 126 may specify that only the first avatar 206 or a group of avatars that includes the first avatar 206 may utilize or be assigned the second virtual currency unit 124. In another example of a permissible use, the tag 126 may specify that the second virtual currency unit 124 may be exchanged for a given amount of real currency. In other examples of permissible uses, the tag 126 may specify that the second virtual currency unit 124 may be utilized to purchase only the first product 212, only products sold in the first store 208, or only products that fulfill or do not fulfill a given condition (e.g., products suitable for children under a certain age, products that meet a minimal score in a particular rating system).

In one example of an impermissible use, the tag 126 may specify that the second avatar 222 or a group of avatars including the second avatar 222 are not permitted to utilize or be assigned the second virtual currency unit 124. In another example of an impermissible use, the tag 126 may specify that the second virtual currency unit 124 may not be exchanged for real currency. In other examples of impermissible uses, the tag 126 may specify that the second virtual currency unit 124 may not be utilized to purchase the third product 216, products in the second store 210, or products that fulfill or do not fulfill a given condition (e.g., products that not age appropriate, products that do not meet a minimum safety rating).

A tag may be associated with a virtual currency unit at the creation of the virtual currency unit or at any time thereafter. The tag may be created based on attributes selected or created by the participant providing the virtual currency unit (referred to herein as a provider) to another participant (referred to herein as a recipient). If the tag is created based on attributes selected or created by the provider, the provider can select or create attributes limiting the ways that the recipient can spend the virtual currency unit. In one example, a parent may provide a virtual currency unit to a child. If the parent does not want the child to purchase adult-oriented goods, the parent may associate a tag with the virtual currency unit that limits the utilization of the virtual currency unit as payment for only goods and services rated for children. In another example, a retailer may provide a virtual currency unit to customers. If the retailer wants the customer to utilize the virtual currency unit only at stores selected by the retailer, the retailer may associate a tag with the virtual currency unit that limits the utilization of the virtual currency unit as payment at only certain stores. In yet another example, a promoter may provide a virtual currency unit to a contest winner. If the promoter does not want the contest winner to exchange the virtual currency unit for real currency, the promoter may associate a tag with the virtual currency unit that prohibits the exchange of the virtual currency unit for real currency.

The tag may also be created based on attributes previously selected or created by the recipient. The provider may associate a tag based on the recipient's previously selected or created attributes to a virtual currency unit. In this way, when the provider provides the virtual currency unit with the tag to the recipient, the provider can be assured that the virtual currency unit is associated with a tag that is consistent with the preferences of the recipient. For example, an uncle may provide a virtual currency unit to a niece. If the uncle is unsure of the kind of virtual currency unit desired by the niece, the uncle may associate a tag generated based on attributes selected or created by the niece with the virtual currency unit.

When the first avatar 206 enters the first store 208 and purchases the first product 212, the first avatar 206 may provide either the first virtual currency unit 122 or the second virtual currency unit 124 to purchase the first product 212. In one embodiment, payment of the first and second virtual currency unit 122, 124 to purchase the first product 212 is managed by the virtual currency module 112. In one example, the first avatar 206 provides the first virtual currency unit 122 to the first store 208 to purchase the first product 212. The virtual currency module 112 determines whether the first virtual currency unit 122 is associated with a tag. Since the first virtual currency unit 122 is not associated with a tag, the virtual currency module 112 processes the payment of the first virtual currency unit 122 for the first product 212. The virtual currency module 112 may transmit a message to the virtual world client module 120 informing the first avatar 206 that the payment of the second virtual currency unit 124 was processed.

In another example, the first avatar 206 provides the second virtual currency unit 124 to the first store 208 to purchase the first product 212. Since the second virtual currency unit 124 is associated with the tag, the virtual currency module 112 evaluates the tag 126 to determine whether the tag 126 allows the second virtual currency unit 124 to be used by the first avatar 206 as payment to purchase the first product 212 from the first store 208. If the tag 126 allows the second virtual currency unit 124 to be used by the first avatar 206 as payment to purchase the first product 212 from the first store 208, then the virtual currency module 112 processes the payment of the second virtual currency unit 124 for the first product 212. The virtual currency module 112 may transmit a message to the virtual world client module 120 informing the first avatar 206 that the payment of the second virtual currency unit 124 was processed. On the other hand, if the tag 126 does not allow the second virtual currency unit 124 to be used by the first avatar 206 as payment to purchase the first product 212 from the first store 208, then the virtual currency module 112 does not process the payment of the second virtual currency unit 124 for the first product 212. The virtual currency module 112 may transmit a message to the virtual world client module 120 informing the first avatar 206 that the payment of the second virtual currency unit 124 was not processed.

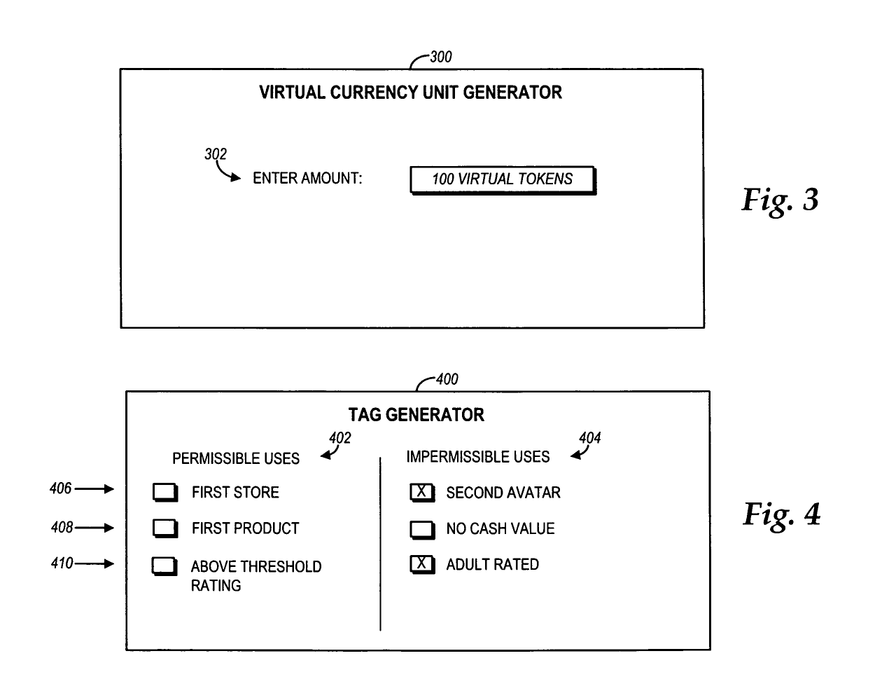

Referring now to FIGS. 3 and 4, additional details will be provided regarding a virtual currency unit generator and a tag generator. In particular, FIG. 3 shows an illustrative screenshot 300 of a simplified virtual currency unit generator for generating virtual currency units, and FIG. 4 shows an illustrative screenshot 400 of a simplified tag generator for generating tags to be associated with the virtual currency units. It should be appreciated that the virtual currency unit generator illustrated in FIG. 3 and the tag generator illustrated in FIG. 4 are merely examples and are not intended to be limiting. Other implementations of the virtual currency unit generator and the tag generator may be utilized as contemplated by those skilled in the art.

Referring to FIG. 3, the illustrative screenshot 300 of a virtual currency unit generator is shown, in accordance with one embodiment. The virtual currency unit generator enables a participant, such as the participant 202, to generate a virtual currency unit. In particular, the screenshot 300 includes an amount field 302. In the amount field 302, a participant may enter an amount of virtual currency to be included in the virtual currency unit. As illustrated in FIG. 3, the participant has input one hundred tokens in the amount field 302. In this case, a virtual currency unit containing one hundred tokens may be generated.

Referring to FIG. 4, the illustrative screenshot 400 of a tag generator is shown, in accordance with one embodiment. The tag generator enables a participant, such as the participant 202, to generate a tag to be associated with the virtual currency unit generated by the virtual currency unit generator of FIG. 3. In particular the screenshot 400 includes a permissible uses column 402 and an impermissible uses column 404. The permissible uses column 402 lists three different options for permissible uses. At a first row 406, under the permissible uses column 402 is a first store option, which enables the virtual currency unit to be used to purchase goods and services at the first store 208. At a second row 408, under the permissible uses column 402 is a first product option, which enables the virtual currency unit to be used to purchase the first product 212. At a third row 410, under the permissible uses column 402 is a threshold option, which enables the virtual currency unit to be used to purchase products that meet a minimum threshold rating.

The impermissible uses column 404 also lists three different options for impermissible uses. At the first row 406, under the impermissible uses column 404 is a second avatar option, which prohibits the second avatar 222 from utilizing or being assigned the virtual currency unit. At the second row 408, under the impermissible uses column 404 is a cash value option, which prohibits the recipient from exchanging the virtual currency unit for real currency. At the third row 410, under the impermissible uses column 404 is an adult rated option, which prohibits the recipient from utilizing the virtual currency unit as payment to purchase adult rated products.

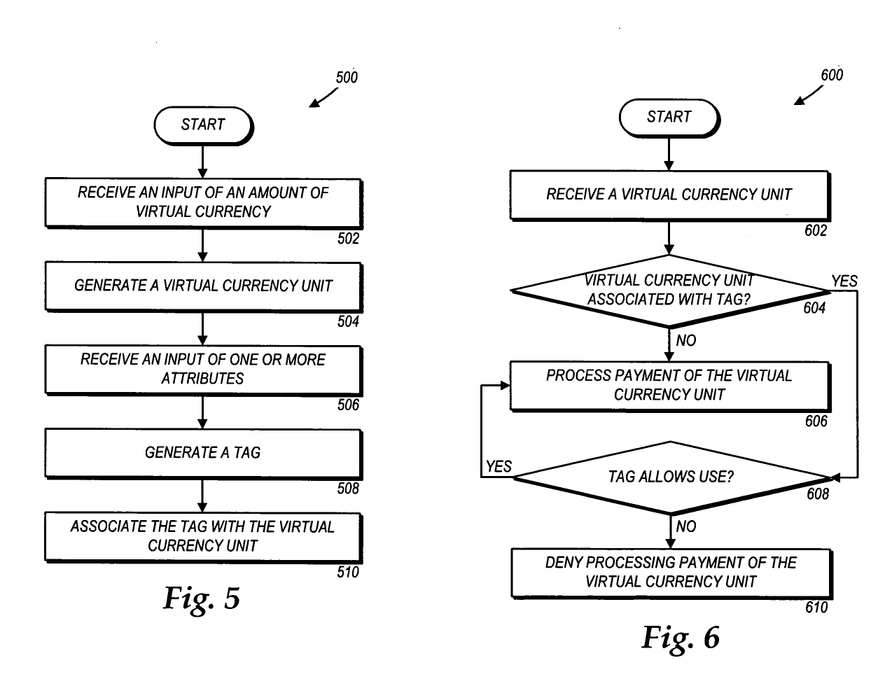

Referring now to FIGS. 5 and 6, additional details will be provided for tagging virtual currency and the processing a payment made by virtual currency. In particular, FIG. 5 shows a routine 500 in which the virtual currency module 112, for example, generates a tag to be associated with a virtual currency unit, in accordance with one embodiment. Further, FIG. 6 shows a routine 600 in which the virtual currency module 112, for example, processes as payment a virtual currency unit and any tags associated with the virtual currency unit, in accordance with one embodiment. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 5, the routine 500 begins at operation 502 where the virtual currency module 112 receives an input of an amount of virtual currency for generating a virtual currency unit, such as the first virtual currency unit 122 and the second virtual currency unit 124. For example, as illustrated in FIG. 3, the participant has input an amount of one hundred tokens at the amount field 302. Upon receiving the input of the amount of virtual currency, the routine 500 proceeds to operation 504 where the virtual currency module 112 generates the virtual currency unit based on the inputted amount of virtual currency. Upon generating the virtual currency unit, the routine 500 proceeds to operation 506.

At operation 506, the virtual currency module 112 receives an input of one or more attributes controlling the utilization of the virtual currency unit in the virtual world. As previously mentioned, the attributes may include permissible uses and/or impermissible uses of the virtual currency unit as payment for good and services. In one embodiment, the attributes may be selected from a list of predefined attributes, such as the permissible uses column 402 and the impermissible uses column 404 illustrated in FIG. 4. In another embodiment, the attributes may be created by the participant using, for example, XML. Upon receiving the input of attributes, the routine 500 proceeds to operation 508 where the virtual currency module 112 generates a tag, such as the tag 126, based on the inputted attributes. Upon generating the virtual currency unit and the tag, the routine 500 proceeds to operation 510.

At operation 510, the virtual currency module 112 associates the virtual currency unit with the tag. For example, the tag 126 is associated with the second virtual currency unit 124, as illustrated in FIGS. 1 and 2. The tag may be associated with the virtual currency unit in any suitable manner as contemplated by those skilled in the art. For example, the tag may include a pointer to the virtual currency unit. In this way, the tag and the virtual currency unit may be stored in separate locations. The tag and the virtual currency unit may also be stored in the same location. Upon associating the virtual currency unit with the tag, the routine 500 ends.

Referring to FIG. 6, the routine 600 begins at operation 602 where the virtual currency module 112 receives a virtual currency unit, such as the first virtual currency unit 122 and the second virtual currency unit 124. The routine 600 may receive the virtual currency unit as payment in exchange for goods and services. The goods and services may be sold by a virtual store, such as the first store 208 and the second store 210, as provided by the virtual store module 114. Upon receiving the virtual currency unit, the virtual currency module 112 proceeds to operation 604.

At operation 604, the virtual currency module 112 determines whether the virtual currency unit is associated with a tag. In one example, if the virtual currency unit is the first virtual currency unit 122, then the virtual currency module 112 will determine that the first virtual currency unit 122 is not associated with a tag. In another example, if the virtual currency unit is the second virtual currency unit 124, then the virtual currency module 112 will determine that the second virtual currency unit 124 is associated with the tag 126. If at operation 604, the virtual currency module 112 determines that the virtual currency unit is not associated with a tag, the routine 600 proceeds to operation 606. On the other hand, if at operation 604, the virtual currency module 112 determines that the virtual currency unit is associated with a tag, the routine 600 proceeds to operation 608.

At operation 606, the virtual currency module 112 processes the payment of the virtual currency unit as payment in accordance with the predefined rules of the virtual world. For example, the virtual world may automatically restrict the use of virtual currency for specific users (e.g., users under a certain age) separate from the utilization of tags. Once the payment of the virtual currency unit is processed, the virtual currency module 112 may also inform a virtual store or other entity that the virtual currency unit has been successfully processed. For example, the virtual store may not provide the good or service without assurance that the virtual currency unit is successfully processed. Upon processing the payment of the virtual currency unit at operation 606, the routine 600 ends.

At operation 608, the virtual currency module 112 determines whether the tag associated with the virtual currency unit allows the virtual currency module 112 to be utilized in the way desired by the participant 202. If at operation 608, the virtual currency module 112 determines that the tag associated with the virtual currency unit allows the virtual currency module 112 to be utilized in the way desired by the participant 202, them the routine 600 proceeds to operation 606, where the virtual currency module 112 processes the payment of the virtual currency unit in accordance with the predefined rules of the virtual world. Upon processing the payment of the virtual currency unit at operation 606, the routine 600 ends. In contrast, if at operation 608, the virtual currency module 112 determines that the tag associated with the virtual currency unit does not allow the virtual currency module 112 to be utilized in the way desired by the participant 202, then the routine 600 proceeds to operation 610.

At operation 610, the virtual currency module 112 denies the processing of the virtual currency unit as payment. The virtual currency module 112 may also inform a virtual store or other entity that the virtual currency unit has been denied. Upon denying the processing of the payment of the virtual currency unit at operation 610, the routine 600 ends.

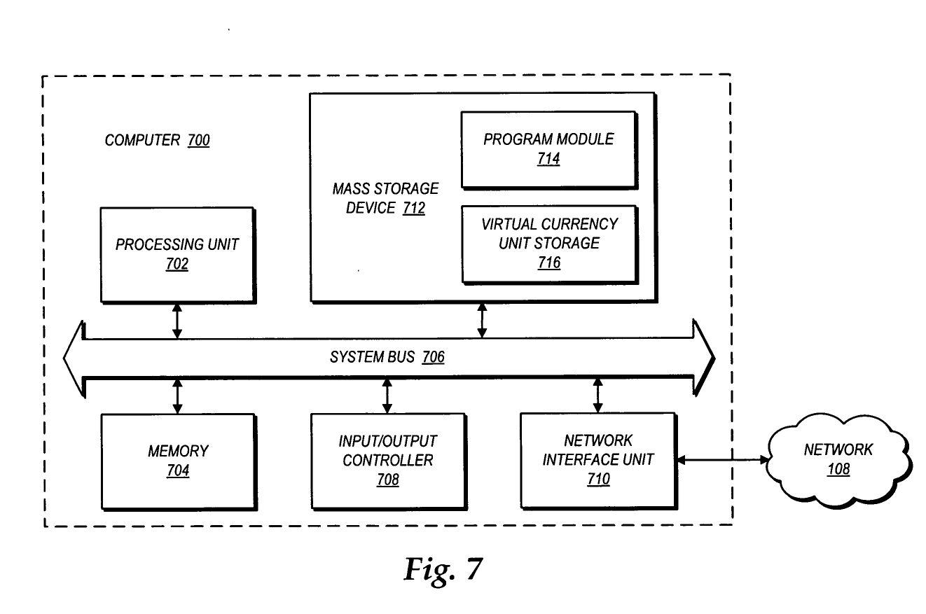

Referring now to FIG. 7, an exemplary computer architecture diagram showing aspects of a computer 700 is illustrated. Examples of the computer 700 may include the server computer 102 and the client device 104. The computer 700 includes a processing unit 702 (“CPU”), a system memory 704, and a system bus 706 that couples the memory 704 to the CPU 702. The computer 700 further includes a mass storage device 712 for storing one or more program modules 714 and one or more virtual currency units at the virtual currency unit storage 716. Examples of the program modules 714 may include the virtual world client module 120, the virtual world server module 110, the virtual currency module 112, and the virtual store module 114. The virtual currency unit storage 716 may the first virtual currency unit 122 and the second virtual currency unit 124. Any associated tags, such as the tag 126, may also be stored in the virtual currency unit storage 716. Alternatively, the tags may be stored in a separate storage (not shown). The mass storage device 712 is connected to the CPU 702 through a mass storage controller (not shown) connected to the bus 706. The mass storage device 712 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available computer storage media that can be accessed by the computer 700.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 108. The computer 700 may connect to the network 108 through a network interface unit 710 connected to the bus 706. It should be appreciated that the network interface unit 710 may also be utilized to connect to other types of networks and remote computer systems. The computer 700 may also include an input/output controller 708 for receiving and processing input from a number of input devices (not shown), including a keyboard, a mouse, a microphone, and a game controller. Similarly, the input/output controller 708 may provide output to a display or other type of output device (not shown).

Based on the foregoing, it should be appreciated that technologies for tagging virtual currency and processing payments made by the virtual currency are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for processing a payment made by virtual currency, the method comprising:
receiving a virtual currency unit as payment for a good or service;
determining whether the virtual currency unit is associated with a tag;
upon determining that the virtual currency unit is associated with the tag, determining whether the tag permits a utilization of the virtual currency unit as payment for the good or service;
upon determining that the tag permits the utilization of the virtual currency unit as payment for the good or service, processing the payment of the virtual currency unit for the good or service; and
upon determining that the tag prohibits the utilization of the virtual currency unit as payment for the good or service, denying the payment of the virtual currency unit for the good or service.

2. The method of claim 1, wherein receiving a virtual currency unit as payment for a good or service comprises receiving the virtual currency unit as payment for a virtual good or virtual service sold by a virtual store within a virtual world.

3. The method of claim 1, wherein the tag comprises a schema identifying permissible uses of the virtual currency unit.

4. The method of claim 1, wherein the tag comprises a schema identifying impermissible uses of the virtual currency unit.

5. The method of claim 1, wherein the tag comprises extensible markup language (XML).

6. The method of claim 1, wherein upon determining that the virtual currency unit is associated with a tag, the method further comprises processing the payment of the virtual currency unit for the good or service.

7. The method of claim 1, wherein processing the payment of the virtual currency unit for the good or service comprises processing the payment of the virtual currency unit for the good or service in accordance with predefined rules of a virtual world.

8. The method of claim 1, further comprising upon processing the payment of the virtual currency unit for the good or service, notifying a virtual store selling the good or service that the payment has been processed.

9. The method of claim 1, further comprising upon denying the payment of the virtual currency unit for the good or service, notifying a virtual store selling the good or service that the payment has been denied.

10. A computer-readable medium having computer-executable instructions stored thereon which, when executed by a computer, cause the computer to perform the method of claim 1.

11. A method for tagging virtual currency, the method comprising:
receiving an input of an amount of virtual currency;
generating a virtual currency unit based on the amount of virtual currency;
receiving an input of at least one attribute controlling a utilization of the virtual currency unit in a virtual world;
generating a tag based on the at least one attribute controlling the utilization of the virtual currency unit in the virtual world; and
associating the virtual currency unit with the tag.

12. The method of claim 11, wherein receiving an input of an amount of virtual currency comprises:
receiving an amount of real currency for purchasing the virtual currency unit; and
determining the amount of virtual currency based on the amount of real currency and an exchange rate.

13. The method of claim 11, wherein receiving an input of at least one attribute controlling a utilization of the virtual currency unit in a virtual world comprises receiving an input of at least one attribute indicating a permissible way to utilize the virtual currency unit in the virtual world.

14. The method of claim 13, wherein receiving an input of at least one attribute indicating a permissible way to utilize the virtual currency unit in the virtual world comprises receiving a selection of a virtual store at which the virtual currency unit is permitted to be utilized to purchase goods or services.

15. The method of claim 11, wherein receiving an input of at least one attribute controlling a utilization of the virtual currency unit in a virtual world comprises receiving an input of at least one attribute indicating an impermissible way to utilize the virtual currency unit in the virtual world.

16. The method of claim 15, wherein receiving an input of at least one attribute indicating an impermissible way to utilize the virtual currency unit in the virtual world comprises receiving a selection of a no cash option prohibiting an exchange of the virtual currency unit for an amount of real currency.

17. The method of claim 11, wherein generating a tag based on the at least one attribute controlling the utilization of the virtual currency unit in the virtual world comprises generating a schema containing the at least one attribute.

18. The method of claim 17, wherein associating the virtual currency unit with the tag comprises inserting into the schema a pointer to the virtual currency unit.

19. A computer-readable medium having computer-executable instructions stored thereon which, when executed by a computer, cause the computer to perform the method of claim 11.

20. A computer-readable medium having computer-executable instructions stored thereon which, when executed by a computer, cause the computer to:
provide for sale a virtual good or virtual service by way of a virtual store in a virtual world;
receive a virtual currency unit as payment for the virtual good or virtual service, the virtual currency unit corresponding to an amount of virtual currency;
determine whether the virtual currency unit is associated with a tag, the tag containing at least one attribute controlling a utilization of the virtual currency unit;
upon determining that the virtual currency unit is associated with the tag, determine whether the at least one attribute permits the utilization of the virtual currency unit as payment for the virtual good or virtual service;
upon determining that the at least one attribute permits the utilization of the virtual currency unit as payment for the virtual good or virtual service, process the payment of the virtual currency unit for the virtual good or virtual service; and
upon determining that the at least one attribute prohibits the utilization of the virtual currency unit as payment for the virtual good or virtual service, deny the payment of the virtual currency unit for the virtual good or virtual service.
